(19) United States
(12) Patent Application Publication
(10) Pub. No.: US 2005/0192922 A1
(43) Pub. Date: Sep. 1, 2005

(54) Client-server computing system capable of validating cached data based on data transformation

(76) Inventors: Stefan Bengt Edlund, San Jose, CA (US); James Harvey Kaufman, San Jose, CA (US)

Correspondence Address: LEONARD T. GUZMAN;IBM CORPORATION, INTELLECTUAL PROPERTY LAW, 650 HARRY ROAD, DEPT. C4TA/J2B, San Jose, CA, 95120-6099, US

(21) Appl. No.: 10/789,743

(22) Filed: Feb. 27, 2004

(51) Int. Cl. G06F 17/30

(52) U.S. Cl. 707/1

(57) ABSTRACT

The present invention provides a client-server computing system capable of validating cached data having a data store, a server, a cache, a transformation engine, a cache monitor, and an object dependency mapper. The transformation engine transforms data into a format suitable for a client application based on a set of transformation rules. The cache monitor ensures that cached objects are valid when changes to data in the data store are detected by the server. The object dependency mapper automatically and continuously determines the dependencies between data in the data store and sets of transformation rules. Data in the data store is represented as a tree structure. The cache monitor determines the validity of the cached objects based on the tree structure and the dependencies between data and the transformation rules.

### TECHNICAL FIELD

The invention relates generally to computer systems, and more particularly to a client-server computing system and a method for validating cached data based on an analysis of data transformation.

### BACKGROUND OF THE INVENTION

Retrieving data from an information system such as a relational database introduces a time cost into an application due to the inherent delays associated with searching for the requested information, extracting the information and returning the information to the application. A data cache memory is usually used to minimize the delays for at least the searching and extracting portions of the retrieval process. The results of the initial queries are temporarily stored in the cache memory which can then be returned to the client applications in their future requests for the same data. A caching system typically first analyzes a query sent by a client application to determine whether the requested data might have been cached. If the result for the query is currently in the cache memory, then the query result can immediately be returned to the application to avoid the delays and overheads associated with the processing of a new query to the database. However, the cached data is not valid forever. Whenever information is created, updated or deleted in the database, all cached data, typically in the form of cached data objects, is in jeopardy of being invalid or obsolete. As an example, materialized views have been used in the relational databases as a caching solution for complex and costly queries. In some cases, it is acceptable to a client application if the information stored in a materialized view is not up-to-date. The application can always force the materialized view to refresh itself when necessary.

On the World Wide Web, the caching of Web data is handled in a different manner because the content of a Web page typically includes both static data and dynamic data. Static data never change or change very rarely such as the names of countries, states and cities. On the other hand, dynamic data is often derived from volatile data and tend to get updated frequently. Examples of dynamic data include weather forecast and stock prices. The dynamic parts of a Web page are expensive to create since they commonly involve querying large data repositories such as the relational databases. However, it is difficult to cache Web pages without the risk of serving stale data. A traditional caching solution for Web data has been to utilize the proxy servers.

A proxy server is an intermediate server located between the user and the host server on which the requested data is stored. The proxy server intercepts the user's http request, caches the returned data for later use in responding to future client requests, and delivers the data to the user across the Internet. An example of the proxy server is the IBM WebSphere Edge Server, version 2.0, offered by IBM Corporation of Armonk, N.Y. The host server (also referred to as the content provider) provides data expiration information in the header of the returned Web page, which is then used by the proxy server to decide whether or not a cached page needs to be refreshed. A problem the expiration information provided by the host server is that the host server cannot always predict the expiration time of the Web pages that it serves. For example, the data may change and expire based on the actions of a second user who adds data to or removes data from a database on the host server. As a result, dynamic Web applications such as Web calendaring and online banking applications suffer from the performance bottlenecks that are caused by the lack of effective caching mechanisms.

A solution often adopted by the Web servers is to associate an expiration time with each Web page that is supplied by the servers. A client or a proxy server can cache the page up until the time that the page expires. After the expiration time, the client or the proxy server would need to obtain a fresh version of the page from the server. A major drawback of this process is that it does not prevent stale data from being served. In addition, it can often be difficult to determine the expiration settings for a large number of Web pages.

U.S. Pat. No. 6,026,413 by Challenger et al. describes a method for determining how changes to the underlying data affect cached objects in Web page applications and client-server applications. The invention by Challenger et al. identifies the underlying data which may or may not be cacheable, maps the underlying data to one or more data objects that depend on the data, and maintains an object dependency graph that represents the data objects and the dependencies between the objects. The invention then uses the object dependency graph to determine how the cached objects are affected when data is updated. While this solution addresses the problem of dynamic data in a Web page, it is difficult to design and maintain the object dependency graphs for relatively complex applications.

U.S. Pat. No. 6,249,844 by Schloss et al. describes a method for identifying the dynamic portions and the static portions of Web pages and decomposing the documents into static and dynamic fragments. This allows for the caching of the static fragments to improve the performance of the applications. The invention, however, does not address the problem of caching the dynamic fragments of the Web pages.

In the paper entitled “Caching Strategies for Data-intensive Web Sites,” Proceedings of the 26^{th} VLDB Conference, 2000, K. Yagoub et al. introduce a Web site management system that uses a customizable cache system for data materialization. The system considers factors like the type of data that should be materialized, where the intermediate results are stored for best performance, how updates from the database are propagated to the materialized data, and which data items must be materialized and which ones must be computed upon request. Although these caching considerations improve the performance of the data-intensive Web sites, they do not specifically address the problem of handling stale data in the cache.

Therefore, there remains a need for a computing system and a method for validating cached data based on the transformation of data without the drawbacks of the prior art systems as described above.

### SUMMARY OF THE INVENTION

It is an object of the present invention to provide a client-server computing system capable of validating data in a cache memory in view of updates to data in the data store.

It is another object of the invention to provide a client-server computing system that validates cached data based on information about the transformation of the data.

It is yet another object of the invention to provide a client-server computing system in which data is transformed into a format suitable for the client application based on a set of transformation rules.

It is still another object of the invention to provide a client-server computing system that automatically and continuously determines the dependencies between data in the data store and the transformation rules to help identify the cached data objects that are affected by the data updates.

To achieve these and other objects, the invention provides a client-server computing system that includes: a data store, a cache, a transformation engine, a cache monitor and an object dependency mapper. The transformation engine transforms data into a format suitable for a client application based on a set of transformation rules. The cache monitor ensures that cached data objects are validated when changes to data in the data store are detected by the server. The object dependency mapper automatically and continuously determines the dependencies between data in the data store and groups of the transformation rules referred to as style sheets. These dependencies are used by the system to identify the cached data objects that are affected by the data updates.

The preferred embodiment of the invention further includes an object manager for managing the data objects in the cache and a transformation rule alert service for detecting when the transformation rules are modified, added to the system or deleted from the system. The server would access the object manager in generating a response to a client request for data. If the requested data is not in the cache, the object manager uses the transformation engine to generate a new data object in response to a client request. The object manager also stores the new data object into the cache automatically so that the object can be used in responding to future requests of the same data. When a data update request is received from a client, the object manager accesses the cache monitor to validate the cached data objects before cached data is returned to the client. To retain only useful data in the cache and to keep the amount of cached data at a manageable level, the object manager periodically cleans up the cache by refreshing and removing the objects that have been flagged as invalid by the cache monitor. Alternatively, the object manager may maintain usage statistics for the data objects in the cache and automatically remove those objects that are being accessed infrequently by the clients.

In the preferred embodiment of the invention, data in the data store is represented as a tree structure to facilitate the identification of the cached data objects that are affected by data updates. The tree structure includes a root node, intermediate nodes and leaf nodes, where each leaf node represents a data item in the data store. A transformation rule is an XPath expression describing the path from the root node to a particular node in the tree. It is also beneficial to consider the transformation rules that are used to transform data into a particular data object as a group called a style sheet. The transformation engine receives a style sheet and the data tree as input, and outputs a transformed data object. The data objects in the cache thus correspond to a group of style sheets that have been used to generate the data objects. The object dependency mapper preferably includes a table of dependencies that is automatically generated and maintained by the object dependency mapper. Each dependency in the table associates a transformation rule with the style sheets that include this particular transformation rule. The transformation rule alert service would communicate any updates to the style sheets to the object dependency mapper. The cache monitor uses the table of dependencies to determine a set of the style sheets that reference the tree nodes corresponding to a data update. It then accesses the cache to invalidate the data objects that were generated based on any of the style sheets in the style sheet set.

Additional objects and advantages of the present invention will be set forth in the description which follows, and in part will be obvious from the description and the accompanying drawing, or may be learned from the practice of this invention.

### BRIEF DESCRIPTION OF THE DRAWING

FIG. 1 is a block diagram of a prior art client-server computing system with a cache memory for caching data.

FIG. 2 is a block diagram showing a prior art proxy server for caching web data on the World Wide Web.

FIG. 3 is a high-level block diagram of the client-server computing system capable of validating cached data in accordance with the invention.

FIG. 4 is a high-level block diagram of the client-server computing system of the invention with an object manager and a transformation rule alert service for improved performance.

FIG. 5 illustrates an example tree data structure for representing data in the data store in accordance with the invention.

FIG. 6 is a flowchart representing the process for validating cached data in accordance with the invention.

FIG. 7 is a flowchart representing a preferred process for determining the data objects in the cache that are affected by data updates in accordance with the invention.

### DESCRIPTION OF THE PREFERRED EMBODIMENTS

The invention will be described primarily as a client-server computing system and a method for validating cached data based on an analysis of the data transformation using data transformation rules. However, persons skilled in the art will recognize that an apparatus, such as a data processing system, including a CPU, memory, I/O, program storage, a connecting bus, and other appropriate components, could be programmed or otherwise designed to facilitate the practice of the invention. Such a system would include appropriate program means for executing the operations of the invention.

Also, an article of manufacture, such as a pre-recorded disk or other similar computer program product, for use with a data processing system, could include a storage medium and program means recorded thereon for directing the data processing system to facilitate the practice of the method of the invention. Such apparatus and articles of manufacture also fall within the spirit and scope of the invention.

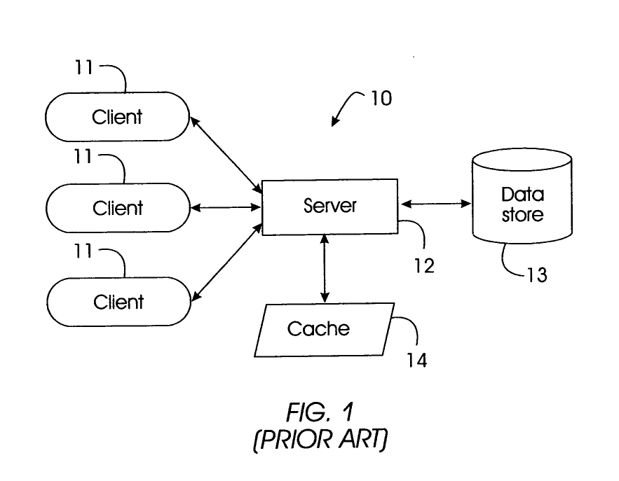

FIG. 1 is a block diagram of a prior art client-server computing system 10 having a cache memory for temporarily storing data to improve the performance of the system. The client-server system 10 includes multiple clients 11 that communicate with a server 12 to access data in a data store 13. The clients 11 can submit requests to the server 12 to retrieve data from the data store 13, update data, and store data in the data store 13. The server 12 stores recently accessed data or frequently accessed data in a high-speed cache memory 14 for future use whenever the same data is requested again by the clients 11. By returning data from the cache memory 14 rather than repeating a query for the data from the data store 13, the time it takes for the server 12 to respond to the clients 11 can significantly be shortened.

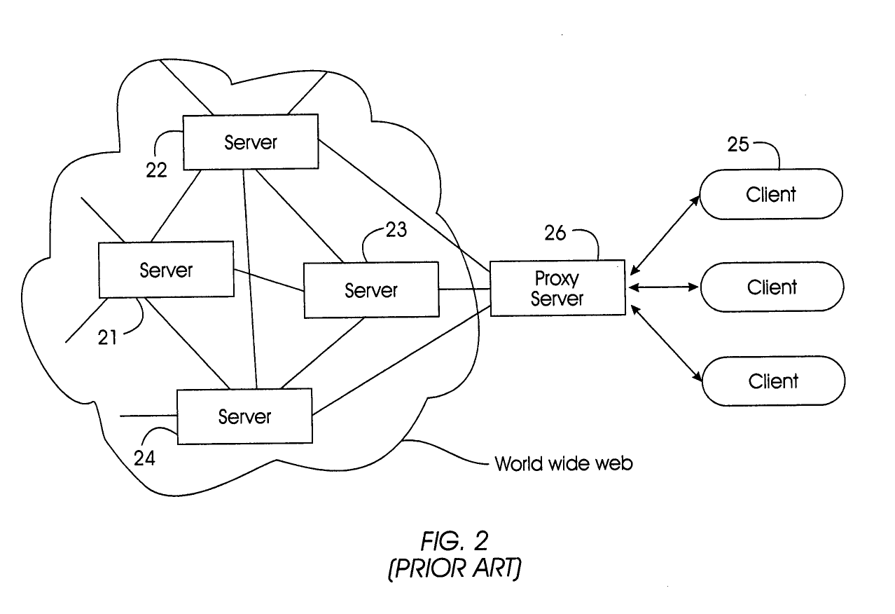

FIG. 2 is a simple representation of the World Wide Web with four interconnected servers 21 through 24 and multiple clients 25. A proxy server 26 positioned on the path between the servers 21-24 and the clients 25 might be used for caching the Web data requested by the clients 25. When a client 25 attempts to download Web data from one of the servers 21-24, the proxy server 26 intercepts the download request and checks whether the requested data is currently stored in the proxy server. If the requested Web data has previously been cached and is now present in the proxy server 26, then the data is returned to the client directly from the proxy server rather than being downloaded again from the servers 21-24. Otherwise, the request is forwarded to one of the servers 21-24 from which the requested data will be sent to the client.

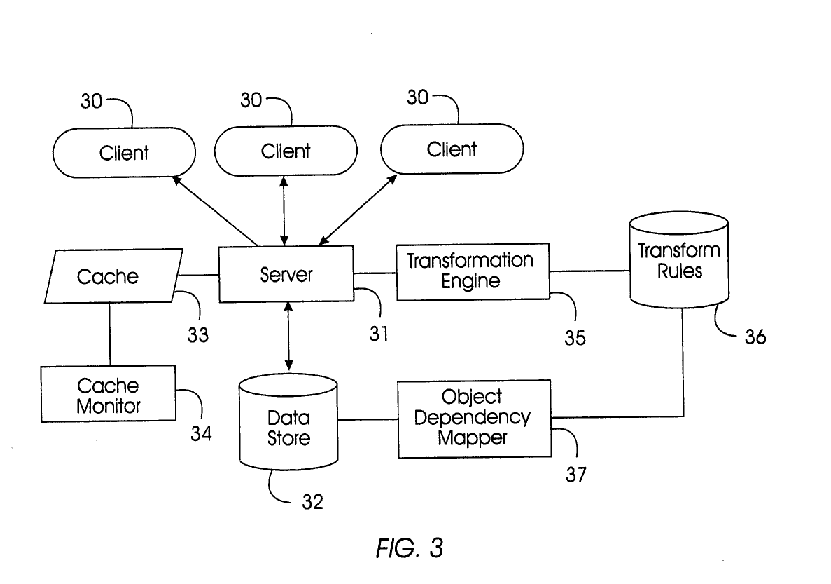

FIG. 3 is a block diagram representing the client-server computing system with the ability to validate cached data in accordance with the invention. An underlying assumption in the invention is the separation between the style of a Web page and its content. In the preferred embodiment of the invention, this separation is realized using the eXtensible Markup Language (XML) and the extensible Stylesheet Language (XSL). To facilitate the description of the invention, these two languages will be referred to in the detailed description of the invention and examples that follow. The separation of the styles and contents of the Web pages allows the dependencies between Web pages and their underlying data to be extracted and used in the identification of invalid cached data. In the preferred embodiment of the invention, the underlying data in the data store 32 is in the form of XML files.

In FIG. 3, the clients 30 communicate with a server 31 to access data stored in a data store 32. The server 31 temporarily stores data as data objects in a cache 33 for servicing the clients in their future requests for the cached data objects. A cache monitor 34 communicates with the cache 33 to ensure that the cached data objects are still valid in view of recent updates to the underlying data in the data store 32. The cache monitor 34 receives XML data update requests from a server application running on the server 31 in the form of XML fragments. An XML fragment consists of an XPath expression that identifies the data in the data store 32 to be updated, inserted or deleted. Further details on the preferred embodiment of the cache monitor 34 are described later in the specification.

A transformation engine 35 transforms data in the data store 32 into a suitable format to be presented to a client 30, such as the hypertext markup language (HTML). The transformation is performed based on a set of transformation rules 36. Each transformation rule refers to a subset of data in the data store 32. A group of the transformation rules in combination with static presentation information is referred to as a style sheet. For example, a style sheet can be used to generate an HTML page containing both dynamic bank account information from a data store and static presentation information using HTML tags. The transformation engine 35 thus receives a style sheet and data from the data store 32 as input, and outputs a data object that has been transformed using the style sheet. In the preferred embodiment of the invention, the transformation rules are implemented using the extensible Stylesheet language (XSL) and include multiple XPath expressions. The XPath expressions refer to portions of the XML data in the data store 32 are referenced by these XPath expressions. The XPath expressions are used to determine how a particular style sheet depends on the underlying XML data, as described below in reference to the object dependency mapper.

The client-server system of the invention further includes an object dependency mapper 37 for determining the dependencies between the style sheets of the transformation rules 36 and the underlying data in the data store 32. A dependency describes a mapping between an XPath expression and a style sheet, and indicates that the XPath expression is included in the style sheet. In the preferred embodiment of the invention, the dependencies between the style sheets and the data in the data store 32 are determined automatically and continuously by the object dependency mapper 37. The object dependency mapper 37 detects when a style sheet has been created, updated or deleted, and automatically rebuilds the dependencies accordingly. Alternatively, the rebuilding of the dependencies might be triggered manually. In the preferred embodiment of the invention, the dependencies are stored in a dependency table that includes the identified XPath expressions. Each XPath expression corresponds to a list of the style sheets that contain that XPath expression. For example, consider the following two style sheets S1 and S2.

Style sheet S1:
<xsl:stylesheet version=″1.0″>
<xsl:template match=″/″>

<html><body>

<xsl:value-of select=″/company/stats/>

</body></html>

</xsl:template>
</xsl:stylesheet>
Style sheet S2:
<xsl:stylesheet version=″1.0″>
<xsl:template match=″/″>

<html><body>

<xsl:value-of select=″/customers″/>

</body></html>

</xsl:template>
</xsl:stylesheet>

The style sheet S1 shows statistics on the number of employees in a particular company. The style sheet S2 shows information about the company's customers. Assume that the underlying XML data is as follows:

<?xml version=″1.0″?>
<root>

<company num−employees=″250″>
<customers>

<cust1 name=″John″/>
<cust2 name=″Sue″/>

</customers>

</root>

Given the style sheets S1 and S2 and the underlying data, the object dependency mapper 37 generates a dependency table that might look like the Table 1 below:

TABLE 1

| | |
|---|---|
| /company/stats | S1 |
| /customers | S2 |

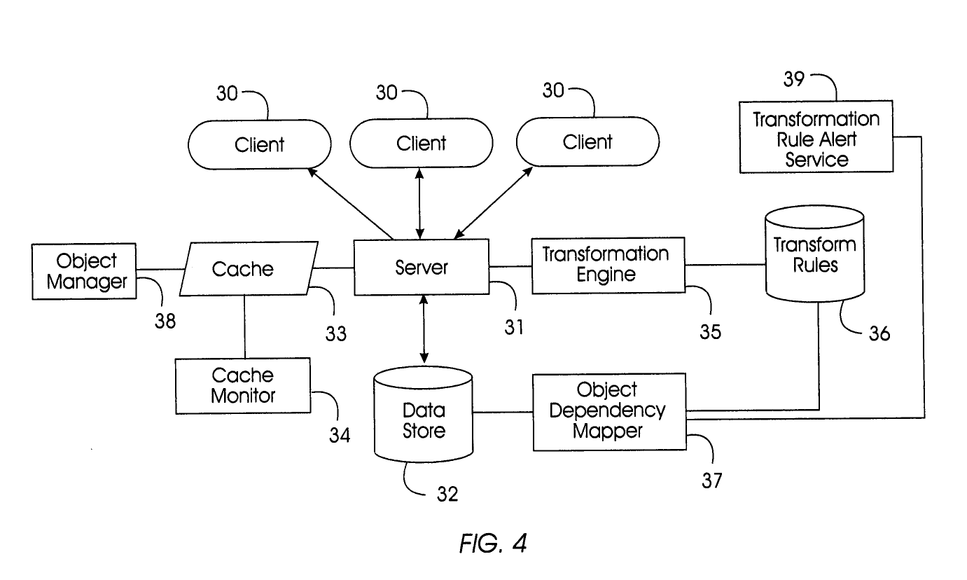

FIG. 4 is a block diagram of a preferred embodiment of the client-server computing system of the invention. The system includes the additional components object manager 38 and transformation rule alert service 39 for improved performance. The object manager 38 generates new data objects for the cache 33 and refreshes the data objects currently in the cache 33 in response to requests for data from the server 31. The object manager 38 constructs the new data objects when needed, for example, as a result of a data transformation. In addition, whenever the serve 31 issues a data refresh request, the object manager 38 immediately rebuilds the relevant cached data objects. Optionally, the object manager 38 periodically examines the cached data objects and refreshes those objects that have expired, i.e., those that have been indicated as being invalid by the cache monitor 34. To decide how frequently a data object should be refreshed, the object manager 38 can either use the profile information associated with each type of cached data objects or use statistics gathered by a server application. The frequently used data objects in the cache 33 would be refreshed more often by the object manager 38 while infrequently accessed objects are automatically removed from the cache 33 by the object manager 38.

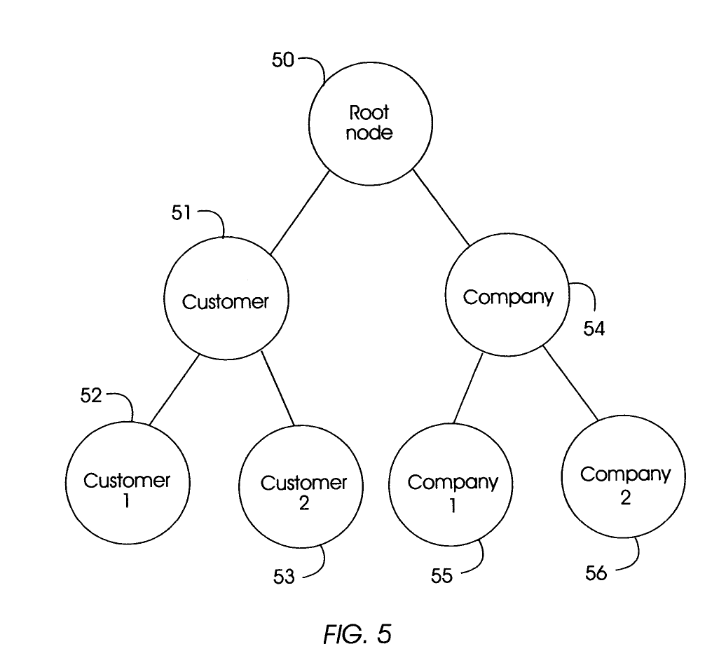

The client-server system in FIG. 4 further shows a transformation rule alert service 39 for detecting when the transformation rules 36 are modified, added to, or deleted from the transformation rule database 36. The transformation rule alert service 39 informs the object dependency mapper 37 of the updated style sheets, and subsequently the object dependency mapper 37 regenerates the table of dependencies. In the preferred embodiment of the invention, data in the data store 32 is represented as a tree data structure to facilitate the identification of the data objects in the cache 33 that are affected by data changes in the data store 32. FIG. 5 depicts an example tree structure having a root node 50, intermediate nodes 51 and 54, and leaf nodes 52-53 and 55-56. The root node 50 has no parent nodes. The leaf nodes have no child nodes. Each intermediate node has both a parent node and at least one child node. Each node has a node ID, e.g., Customer 1, and contains data as well as other attributes of the data. A transformation rule is an expression for the path from the root node to a particular node in the tree in terms of the node IDs. For example, the expression /company/stats refers to the node in the tree that contains the statistics for a particular company, e.g., the number of employees in the company.

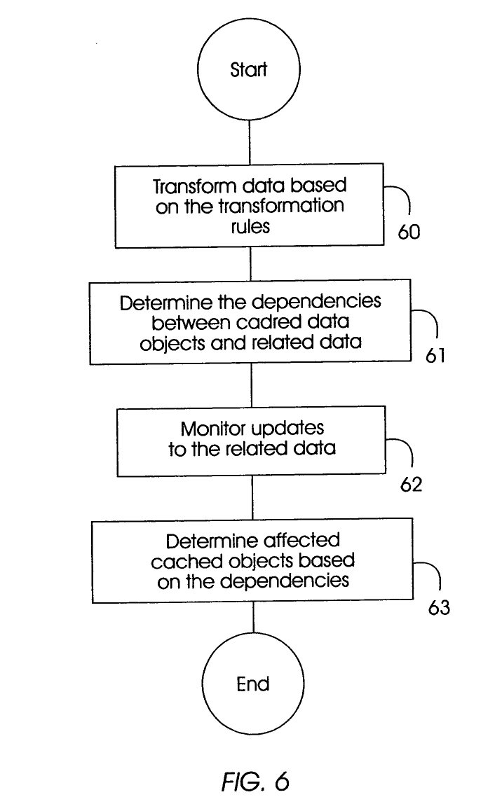

FIG. 6 is a flowchart representing the high-level operations of the client-server computing system of the invention for validating the cached data objects in its cache. At step 60, data in the data store is transformed into a format suitable for a client application based on a set of transformation rules. A preferred format in the Web environment is html. As described above in reference to FIGS. 3-4, a set of the transformation rules that are used to transform a data object is referred to as a style sheet. At step 61, the system determines the dependencies between the data objects currently in the cache memory and their underlying data in the data store by accessing the table of dependencies. At step 62, the system monitors updates to the underlying data that might affect the cached objects. At step 63, the data objects in the cache that are affected by the data updates are determined based on the dependencies.

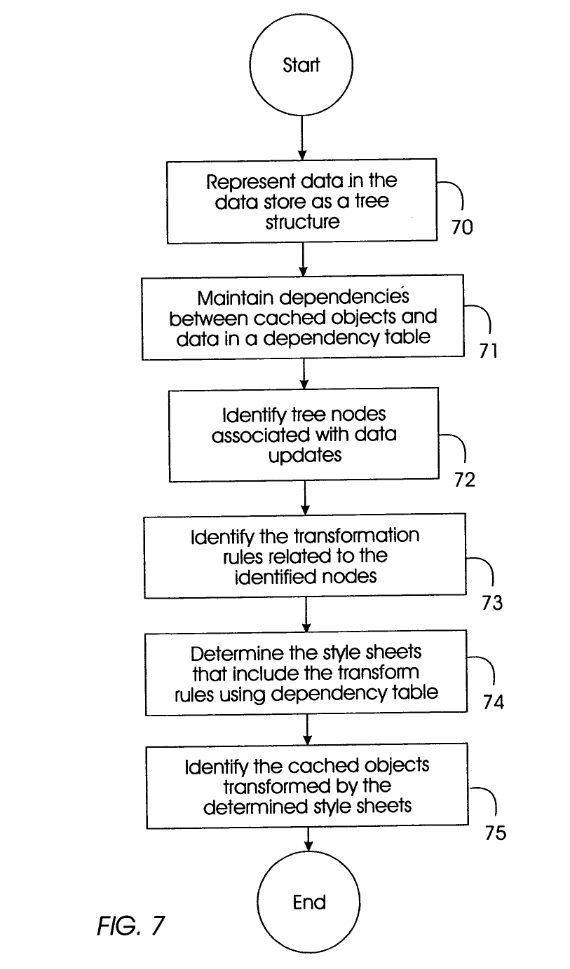

FIG. 7 is a flowchart representing a preferred embodiment of step 63, for determining the affected data objects in the cache. At step 70, data in the data store is represented as a tree structure to facilitate the identification of the cached data objects that are affected by data updates. The tree includes a root node, intermediate nodes and leaf nodes. Further details on the tree structure were described above in reference to FIG. 5. At step 71, the dependencies between the data objects in the cache and their corresponding data in the data store are automatically identified and maintained in a dependency table by the transformation rule alert service. At step 72, the invention identifies the tree nodes that are affected by data updates in the data store. This is done by examining each data update to identify the relevant XPath expressions and the nodes referenced by these XPath expressions. At step 73, the transformation rules in the table of dependencies that include the referenced nodes are determined. A transformation rule includes a node if it references that node or any of its parent nodes. At step 74, the invention determines the style sheets that include the determined transformation rules. At step 75, the cached data objects that have been transformed by these style sheets are indicated as being invalid by the object manager due to updates in the data store.

While the present invention has been particularly shown and described with reference to the preferred embodiments, it will be understood by those skilled in the art that various changes in form and detail may be made without departing from the spirit and scope of the invention. Accordingly, the disclosed invention is to be considered merely as illustrative and limited in scope only as specified in the appended claims.

1. A client-server system capable of validating cached data comprising:
a data store for storing data;
a server for retrieving and updating data in the data store to service client requests;
a transformation engine for transforming data into a format suitable for a client application based on a set of transformation rules;
a cache for temporarily storing transformed data as data objects for later reuse;
a cache monitor for ensuring that cached objects are validated when changes to data in the data store are detected by the server; and
an object dependency mapper for automatically and continuously determining dependencies between data in the data store and sets of transformation rules.

2. The system as recited in claim 1 further comprising an object manager for managing data objects in the cache.

3. The system as recited in claim 2 further comprising a transformation rule alert service for detecting when the transformation rules are modified, added to the system and deleted from the system.

4. The system as recited in claim 3, wherein the server accesses the object manager to generate a response to a client request for data.

5. The system as recited in claim 4, wherein the server accesses the cache monitor to validate cached objects when a data update request is received.

6. The system as recited in claim 5, wherein:
data in the data store is represented as a tree structure having a root node, a plurality of intermediate nodes and leaf nodes, the leaf nodes representing data in the data store; and
a transformation rule is an expression describing a path from the root node to a particular node in the tree.

7. The system as recited in claim 6, wherein:
a set of the transformation rules constitutes a style sheet; and
the transformation engine receives a style sheet and the data tree as input, and outputs a transformed data object.

8. The system as recited in claim 7, wherein the cache includes a plurality of data objects each associated with a style sheet used to generate said each object.

9. The system as recited in claim 8, wherein:
the object manager uses the transformation engine to generate a new object in response to a client request when the new object does not exist in the cache; and
the object manager stores the new object in the cache automatically.

10. The system as recited in claim 9, wherein the object manager periodically refreshes the cache and removes the objects that have been flagged as invalid by the cache monitor.

11. The system as recited in claim 9, wherein the object manager optionally maintains statistical information for each object in the cache, and automatically removes cached objects that are being accessed infrequently by the clients.

12. The system as recited in claim 7, wherein the object dependency mapper includes a table of dependencies, each dependency associating a transformation rule with the style sheets that include the transformation rule.

13. The system as recited in claim 12, wherein the table of dependencies is automatically generated and maintained by the object dependency mapper.

14. The system as recited in claim 12, wherein the transformation rule alert service communicates updates on the style sheets to the object dependency mapper.

15. The system as recited in claim 12, wherein the cache monitor uses the table of dependencies to determine a set of relevant style sheets, said relevant style sheets referencing a node in the data tree related to a data update; and
the cache monitor accesses the cache to invalidate the objects generated by the relevant style sheets.

16. In a client-sever computing system having a cache and storing data as data objects, a method for determining invalid cached objects comprising the steps of:
transforming data into a format suitable for a client application based on a set of transformation rules;
determining dependencies between cached objects and data related to the cached objects;
monitoring updates to the related data; and
determining the cached objects that are affected by changes to the related data based on the dependencies.

17. The method as recited in claim 16, wherein the transformed format is html.

18. The method as recited in claim 16, wherein:
a set of transformation rules constitutes a style sheet;
each dependency associates a transformation rule with a style sheet; and
each data object is the data transformed by a style sheet.

19. The method as recited in claim 16, wherein:
data is represented as a tree structure having a plurality of nodes; and
the cached objects that are affected by the data changes are determined using the tree structure.

20. The method as recited in claim 19, wherein the dependencies are maintained in a table of dependencies.

21. The method as recited in claim 20, wherein the step of determining the affected objects comprises the steps of:
identifying the nodes associated with data updates;
identifying the transformation rules related to the identified nodes;
determining a set of relevant style sheets using the table of dependencies, the relevant style sheets including the identified transformation rules; and
identifying the cached objects that have been transformed by the relevant style sheets.

22. In a client-sever computing system having a cache and storing data as data objects, a computer-program product for determining invalid cached objects comprising:
a computer-readable medium;
means, provided on the computer-readable medium, for transforming data into a format suitable for a client application based on a set of transformation rules;
means, provided on the computer-readable medium, for determining dependencies between cached objects and data related to the cached objects; and
means, provided on the computer-readable medium, for monitoring updates to the related data;
means, provided on the computer-readable medium, for determining the cached objects that are affected by changes to the related data based on the dependencies.

23. The computer-program product as recited in claim 22, wherein the transformed format is html.

24. The computer-program product as recited in claim 22, wherein:
a set of transformation rules constitutes a style sheet;
each dependency associates a transformation rule with a style sheet; and
each data object is the data transformed by a style sheet.

25. The computer-program product as recited in claim 22, wherein:
data is represented as a tree structure having a plurality of nodes; and
the cached objects that are affected by the data changes are determined using the tree structure.

26. The method as recited in claim 25, wherein the dependencies are maintained in a table of dependencies.

27. The computer-program product as recited in claim 26, wherein the means for determining the affected cached objects comprises:
means, provided on the computer-readable medium, for identifying the nodes associated with data updates;
means, provided on the computer-readable medium, for identifying the transformation rules related to the identified nodes;
means, provided on the computer-readable medium, for determining a set of relevant style sheets using the table of dependencies, the relevant style sheets including the identified transformation rules; and
means, provided on the computer-readable medium, for identifying the cached objects that have been transformed by the relevant style sheets.
